(19) United States
(12) Patent Application Publication
(10) Pub. No.: US 2019/0280419 A1
(43) Pub. Date: Sep. 12, 2019

(54) RECEPTACLE CONNECTOR OF AN ELECTRICAL CONNECTOR SYSTEM

(71) Applicant: TE CONNECTIVITY CORPORATION, Berwyn, PA (US)

(72) Inventors: Randall Robert Henry, Lebanon, PA (US); Michael John Phillips, Camp Hill, PA (US)

(21) Appl. No.: 15/912,677

(22) Filed: Mar. 6, 2018

(51) Int. Cl. H01R 13/514; H01R 13/6593; H01R 13/6594

(52) U.S. Cl. CPC H01R 13/514; H01R 13/6594; H01R 13/6593

(57) ABSTRACT

An electrical connector system includes a receptacle connector having a housing, a contact assembly held in the housing and an insert movably received in the housing and supporting the contact assembly. The contact assembly includes contacts arranged upper and lower rows. The housing has a cavity receiving the contact assembly and a mating end including a slot open to the cavity and configured to receive a circuit card. The insert is received in the cavity and is movable in the cavity between a forward position and a retracted position. The insert is manufactured from a dielectric material and supports the mating ends of the contacts in the forward position. The mating ends are released from the insert in the retracted position and the mating ends are more exposed to air when the insert is in the retracted position.

### BACKGROUND OF THE INVENTION

The subject matter herein relates generally to receptacle connectors of electrical connector systems.

At least some known electrical connector systems include receptacle connectors, such as input/output (I/O) connectors, that are configured to receive a pluggable module, such as a transceiver module, paddle card, and the like, to establish a communicative connection between the pluggable module and the receptacle connector. As one example, a known electrical connector system includes a cage member surrounding a receptacle connector that is mounted to a circuit board and configured to receive a pluggable transceiver in an elongated cavity of the cage member. The pluggable transceiver including a circuit card and the receptacle connector have respective contacts that engage one another to establish a communicative connection.

Conventional receptacle connectors have housings with contact channels holding the contacts in a slot, such as in an upper row and a lower row. The housings are manufactured from dielectric material that affects the impendence of the receptacle connector, such as in the mating zone. For example, the dielectric material between the contacts lowers the impedance in the mating zone. The contacts typically have varying widths along their lengths, such as being narrower at the tips, leading to variations in the spacing between the contacts along the length. The varied spacing causes the impedance of the contacts to be lower where the contacts have greater spacing and higher where the contacts have narrower spacing. The contacts of the receptacle connector have mating beams including flared ends that are flared outward (away from the mating interface) to reduce the risk of mechanical stubbing and damaging of the contacts during mating with the circuit card. The flared ends extend forward of the mating interfaces, creating an electrical stub at the end of each contact.

### BRIEF DESCRIPTION OF THE INVENTION

In one embodiment, an electrical connector system is provided including a receptacle connector having a housing, a contact assembly held in the housing and an insert movably received in the housing and supporting the contact assembly. The contact assembly includes contacts arranged in an upper row and a lower row each having mating ends. The housing has a cavity receiving the contact assembly. The housing has a mating end including a slot open to the cavity and configured to receive a circuit card having contact pads on an upper surface and a lower surface of the circuit card for mating with the upper and lower rows of contacts. The insert is received in the cavity and being movable in the cavity between a forward position and a retracted position. The insert is manufactured from a dielectric material and supports the mating ends of the contacts in the forward position. The mating ends are released from the insert in the retracted position and the mating ends are more exposed to air when the insert is in the retracted position.

In another embodiment, an electrical connector system is provided including a receptacle connector having a housing, a contact assembly held in the housing and an insert movably received in the housing and supporting the contact assembly. The contact assembly includes contacts arranged in an upper row and a lower row each having mating ends. The housing has a cavity receiving the contact assembly. The housing has a mating end including a slot open to the cavity. The slot has a height and is configured to receive a circuit card having contact pads on an upper surface and a lower surface of the circuit card for mating with the upper and lower rows of contacts. The insert is received in the cavity and is movable in the cavity between a forward position and a retracted position. The insert is manufactured from a dielectric material. The insert has a main body including an upper land and a lower land separated by a distance greater than the height of the slot. The insert supports the mating ends of the contacts in the forward position with the mating ends of the contacts in the upper row being supported by the upper land in a deflected position and with the mating ends of the contacts in the lower row being supported by the lower land in a deflected position such that the contacts are preloaded against the insert. The mating ends are released from the insert in the retracted position for mating with the contact pads of the circuit card.

In a further embodiment, an electrical connector system includes a receptacle connector having a housing, a contact assembly held in the housing and an insert movably received in the housing and supporting the contact assembly. The contact assembly includes a contact holder arranged in the cavity including contacts held by the holder in an upper row and a lower row each having mating ends including mating beams extending forward of the contact holder and tips at distal ends of the mating beams having mating interfaces. The housing has a cavity receiving the contact assembly. The housing has a mating end including a slot open to the cavity configured to receive a circuit card having contact pads on an upper surface and a lower surface of the circuit card for mating with the upper and lower rows of contacts. The insert is received in the cavity and is movable in the cavity between a forward position and a retracted position. The insert is positioned remote from the contact holder in the forward position. The insert is moved toward the contact holder as the insert moves to the retracted position. The insert is manufactured from a dielectric material. The insert has a main body and separating walls extending from the main body defining contact channels therebetween receiving corresponding contacts. The mating interfaces of the contacts are in the contact channels between corresponding separating walls when the insert is in the forward position. The mating interfaces are forward of the insert when the insert is in the retracted position.

### BRIEF DESCRIPTION OF THE DRAWINGS

FIG. 1 is a front perspective view of a communication system in accordance with an embodiment.

FIG. 2 is a front perspective view of the communication system in accordance with an embodiment.

FIG. 3 is a partial sectional view of a receptacle connector of the communication system in accordance with an exemplary embodiment.

FIG. 4 is a partial sectional view of the receptacle connector in accordance with an exemplary embodiment.

FIG. 5 is a partial sectional view of the receptacle connector in accordance with an exemplary embodiment.

FIG. 6 is a bottom perspective view of an insert of the receptacle connector in accordance with an exemplary embodiment.

FIG. 7 is a partial sectional view of a portion of the receptacle connector showing the insert in a forward position.

FIG. 8 is a partial sectional view of a portion of the receptacle connector showing the insert in a retracted position.

FIG. 9 is a partial sectional view of the receptacle connector in accordance with an exemplary embodiment.

FIG. 10 is a partial sectional view of the receptacle connector in accordance with an exemplary embodiment.

FIG. 11 is a partial sectional view of the communication system showing a pluggable module partially loaded into the receptacle connector.

FIG. 12 is a partial sectional view of the receptacle connector in accordance with an exemplary embodiment.

FIG. 13 is a partial sectional view of the receptacle connector in accordance with an exemplary embodiment showing the insert in the forward position.

FIG. 14 is a partial sectional view of the communication system showing the pluggable module partially mated with the receptacle connector.

FIG. 15 is a partial sectional view of the communication system showing the pluggable module mated with the receptacle connector.

FIG. 16 illustrates a portion of the communication system showing the pluggable module partially mated with the receptacle connector.

### DETAILED DESCRIPTION OF THE INVENTION

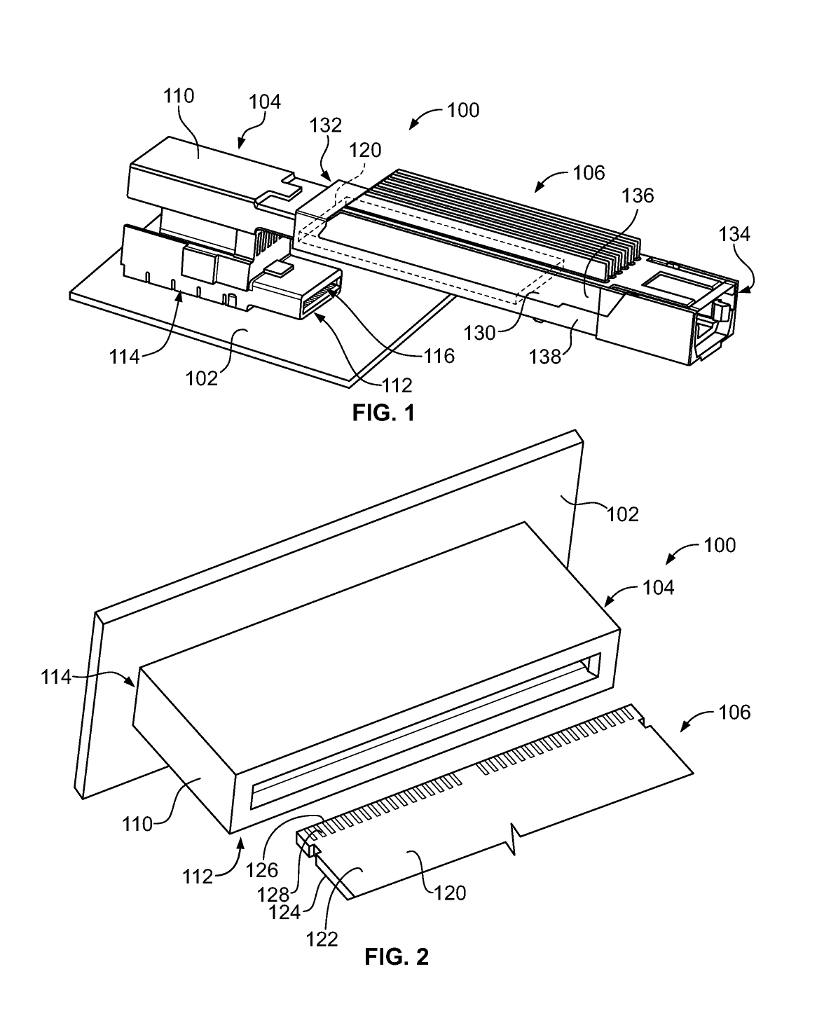

FIG. 1 is a front perspective view of a communication system 100 in accordance with an embodiment. The communication system 100 includes a circuit board 102, a receptacle connector 104 mounted to the circuit board 102, and a pluggable module 106 that is configured to be coupled to the receptacle connector 104. The circuit board 102 may be a daughter card or a mother board and include conductive traces (not shown) extending therethrough. The pluggable module 106 is communicatively coupled to the circuit board 102 through the receptacle connector 104 to send and/or receive data signals with components of the communication system 100.

The communication system 100 may be part of or used with telecommunication systems or devices. For example, the communication system 100 may be part of or include a switch, router, server, hub, network interface card, or storage system. In the illustrated embodiment, the pluggable module 106 is configured to transmit data signals in the form of electrical signals. In other embodiments, the pluggable module 106 may be configured to transmit data signals in the form of optical signals.

The receptacle connector 104 includes a housing 110 having a mating end 112 and a mounting end 114. The mounting end 114 is configured to be mounted to the circuit board 102. The mating end 112 is configured to be mated with the pluggable module 106. In an exemplary embodiment, the housing 110 includes a slot 116 at the mating end 112 that receives a portion of the pluggable module 106. For example, the slot 116 may be a card slot configured to receive a circuit card of the pluggable module 106. The receptacle connector 104 may have multiple mating interfaces at the mating end 112 when configured to mate with multiple pluggable modules 106, such as when used in a stacked cage member. The receptacle connector 104 includes contacts (not shown) that are configured to be mated with the pluggable module 106 and the circuit board 102. The receptacle connector 104 may be incorporated into a cage assembly, such as a single or multi-port cage assembly that provides electrical shielding around the pluggable module 106 and the receptacle connector 104.

In the illustrated embodiment, the pluggable module 106 is an input/output (I/O) module, such as a transceiver module. For example, the pluggable module 106 may be a small form-factor pluggable (SFP) transceiver or quad small form-factor pluggable (QSFP) transceiver, such as those satisfying certain technical specifications for SFP or QSFP transceivers, such as Small-Form Factor (SFF)-8431.Other types of receptacle connectors 104 and pluggable modules 106 may be used in alternative embodiments, such as a card edge connector and a circuit card.

The pluggable module 106 has a pluggable body 130, which may be defined by one or more shells. For example, in the illustrated embodiment, the pluggable body 130 includes an upper shell 136 and a lower shell 138. The pluggable body 130 may be thermally conductive and/or may be electrically conductive, such as to provide EMI shielding for the pluggable module 106. The pluggable body 130 includes a mating end 132 and an opposite cable end 134. The mating end 132 is configured to be mated with the receptacle connector 104. The cable end 134 may have one or more cables (not shown) extending to another component within the system.

In an exemplary embodiment, the pluggable module 106 includes a circuit card 120 (shown in phantom in FIG. 1) held within the pluggable body 130. The circuit card 120 is configured to be communicatively coupled to the receptacle connector 104. The circuit card 120 may be accessible or exposed at the mating end 132. The cables are terminated to the circuit card 120. The circuit card 120 has communication components (not shown) connected thereto for transmitting the signals between the cables and the mating end of the circuit card 120. For example, the circuit card 120 may have conductors, traces, pads, electronics, optical modules, sensors, controllers, switches, inputs, outputs, and the like associated with the circuit card 120, which may be mounted to the circuit card 120, to form circuits and to control operation of the pluggable module 106.

FIG. 2 is a front perspective view of the communication system 100 in accordance with an embodiment. The receptacle connector 104 is shown as a card edge connector (receptacle) mounted to the circuit board 102. The pluggable module 106 is configured to be coupled to the receptacle connector 104. In the illustrated embodiment, the receptacle connector 104 is a pass-through connector having the mating end 112 and the mounting end 114 of the housing 110 parallel to each other rather than perpendicular to each other such that the contacts pass straight through the housing 110 rather than being right angle contacts.

In the illustrated embodiment, the pluggable module 106 includes the circuit card 120. The circuit card 120 includes an upper surface 122 and a lower surface 124. The circuit card 120 includes a card edge 126 at a mating end of the circuit card 120. The circuit card 120 includes contact pads 128 at the card edge 126 configured to be mated with the contacts of the receptacle connector 104.

FIG. 3 is a partial sectional view of the receptacle connector 104 in accordance with an exemplary embodiment. The receptacle connector 104 includes the housing 110, a contact assembly 200 held in the housing 110 and an insert 300 movably received in the housing 110 and supporting the contact assembly 200.

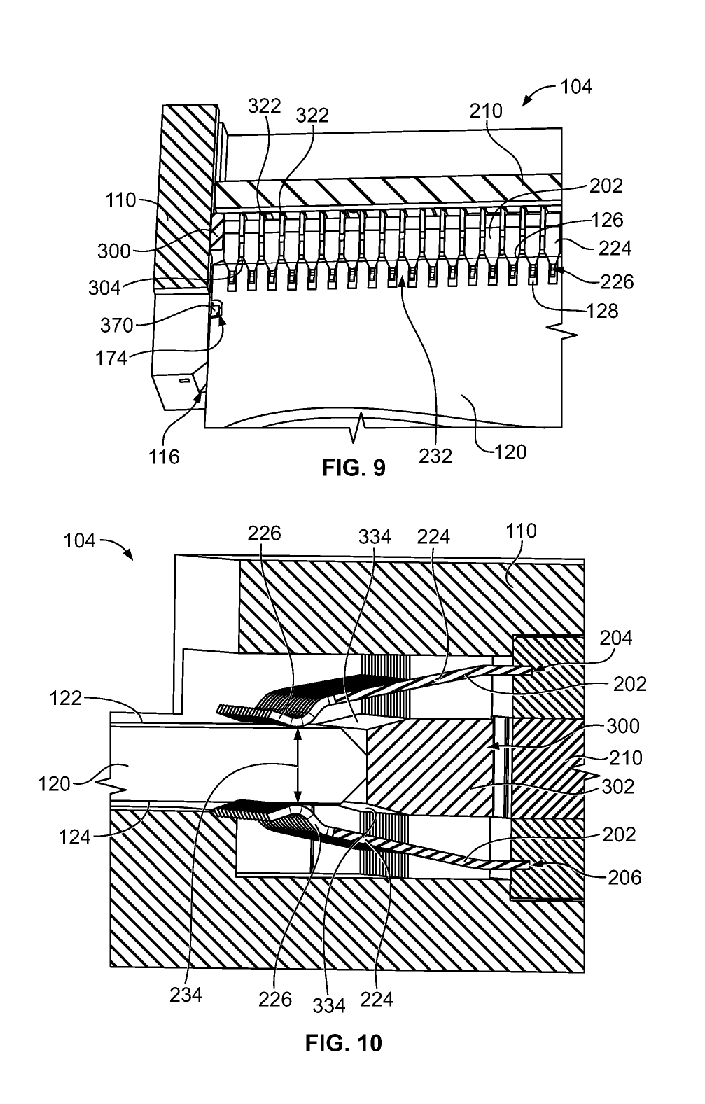

In an exemplary embodiment, the housing 110 is manufactured from a dielectric material, such as a plastic material. The housing 110 may be molded, such as injection molded. The housing 110 may be a single piece or may be assembled from multiple pieces. The housing 110 includes a cavity 150 rearward of the slot 116. The slot 116 is open to the cavity 150. The insert 300 and the contact assembly 200 are held in the cavity 150. In an exemplary embodiment, the cavity 150 includes an insert chamber 152 at a front portion of the cavity 150. The insert 300 is movably received in the insert chamber 152. The insert 300 is movable in the insert chamber 152 of the cavity 150 between a forward position (FIG. 3) and a retracted position (FIG. 10).

The contact assembly 200 includes a plurality of contacts 202 arranged in the cavity 150 for mating with the circuit card 120 (shown in FIG. 1). The contacts 202 may include signal contacts, ground contacts and/or other types of contacts such as power contacts. In an exemplary embodiment, the contacts 202 are arranged in an upper row 204 of contacts and a lower row 206 of contacts. The upper row of contacts 204 are arranged along the top of the cavity 150 and the lower row of contacts 206 are arranged along the bottom of the cavity 150. The circuit card 120 is configured to be received between the upper and lower rows of contacts 204, 206. In an exemplary embodiment, the insert 300 is located between the upper and lower rows of contacts 204, 206.

The contact assembly 200 includes a holder 210 holding the contacts 202. In an exemplary embodiment, the holder 210 is manufactured from a dielectric material to electrically isolate the contacts 202 from each other. In various embodiments, the holder 210 may include a ground bus (not shown) for electrically connecting ground contacts. In an exemplary embodiment, the holder 210 may be overmolded around the array of contacts 202 during manufacture; however, the contacts 202 may be coupled to the holder 210 by other means in alternative embodiments, such as loading or stitching the contacts 202 into the holder 210. Optionally, the holder 210 may include an upper holder and a lower holder holding the upper row of contacts 204 and the lower row of contacts 206, respectively. The holder 210 is held in the cavity 150. In various embodiments, the holder 210 is fixed in the cavity 150, by using latches, fasteners, an interference fit or other securing means. The holder 210 includes a front wall 212 facing the insert chamber 152. The contacts 202 extend forward of the front wall 212.

Each contact 202 includes a base section 220 held by the holder 210. The contact 202 includes a mating end 222 extending forward of the holder 210. The mating end 222 has a mating beam 224 and a tip 226 at a distal end 228 of the mating beam 224. The contact 202 includes a mating interface 230 at the tip 226. Optionally, the tip 226 may be curved to prevent mechanical stubbing when mating with the circuit card 120. In an exemplary embodiment, the length of the tip 226 forward of the mating interface 230 is relatively short to reduce any electrical stub in the contact 202. The mating beam 224 is cantilevered from the holder 210. In an exemplary embodiment, the mating interfaces 230 of each of the contacts 202 in the upper row 204 are coplanar and the mating interfaces 230 of each of the contacts 202 in the lower row 206 are coplanar and spaced apart from the upper row 204.

In an exemplary embodiment, adjacent contacts 202 within a row are separated by contact gaps 232. The spacing of the contact gaps 232 may be controlled by the insert 300. The widths of the contact gaps 232 may be variable along the lengths of the contacts 202. For example, the contact gaps 232 may be narrower along the mating beams 224 and may be wider along the tips 226.

In an exemplary embodiment, when the insert 300 is in the forward position (FIG. 3), the insert 300 supports the mating ends 222 of the contacts 202 in the upper and lower rows 204, 206. For example, the tips 226 rest on the insert 300. The insert 300 spreads the contacts 202 apart to allow the circuit card 120 to be loaded therein without the risk of mechanical stubbing during loading of the circuit card 120 into the slot 116. For example, the insert 300 may spread the contacts 202 apart a greater distance than the thickness of the circuit card 120. The insert 300 may spread the upper row of contacts 204 above an upper wall 154 of the slot 116 and/or the insert 300 may spread the lower row of contacts 206 below a lower wall 156 of the slot 116. The mating ends 222 of the contacts 202 are deflected outward by the insert 300 to preload the contacts with an internal preload force. The contacts 202 have a tendency to return inward when released, causing the contacts 202 to be spring loaded against the circuit card 120 when the circuit card 120 is loaded into the housing 110.

In an exemplary embodiment, the insert 300 is configured to be pushed rearward to the retracted position (FIG. 10) by the circuit card 120 as the circuit card 120 is loaded into the housing 110. The contacts 202 may be released inward to engage the circuit card 120 when the insert 300 is moved rearward to the retracted position. Because the circuit card 120 is already positioned between the tips 226 of the contacts 202 in the upper and lower rows 204, 206 when the contacts 202 are moved inward, there is no risk of mechanical stubbing of the contacts 202 on the circuit card 120 when the circuit card 120 is loaded into the housing 110. As such, the lengths of the tips 226 of the contacts 202 may be shortened compared to conventional contacts that have long tips to define a large catch window for the circuit card 120, such long tips generally creating electrical stubs on the contacts. By shortening the tips 226, the contacts 202 have a shorter electrical stub compared to conventional contacts, enhancing the electrical performance and signal integrity of the contacts 202.

FIG. 4 is a partial sectional view of the receptacle connector 104 in accordance with an exemplary embodiment. FIG. 4 illustrates the insert 300 and the contact assembly 200 in the cavity 150 of the housing 110. A portion of the upper wall of the housing 110 is removed to illustrate the insert 300 and the contact assembly 200. The insert 300 is positioned between the upper row 204 and the lower row 206 of the contacts 202.

In an exemplary embodiment, the mating beams 224 of the contacts 202 are wider than the tips 226 of the contacts 202. The tips 226 may be narrower for electrical connection with the contact pads 128 (shown in FIG. 2) of the circuit card 120 (shown in FIG. 2), such as to avoid inadvertent electrical connection with an adjacent contact pad 128. The tips 226 may be narrower to allow deflection of the contacts 202 at the tips 226, such as when mated with the corresponding contact pads 128. For example, higher flexibility may prevent damage to the contact pads 128 when wiping along the contact pads 128 during mating. The mating beams 224 may be wider for structural integrity of the contacts 202. For example, the wider mating beams 224 may provide sufficient holding or spring force of the contacts 202 against the circuit card 120.

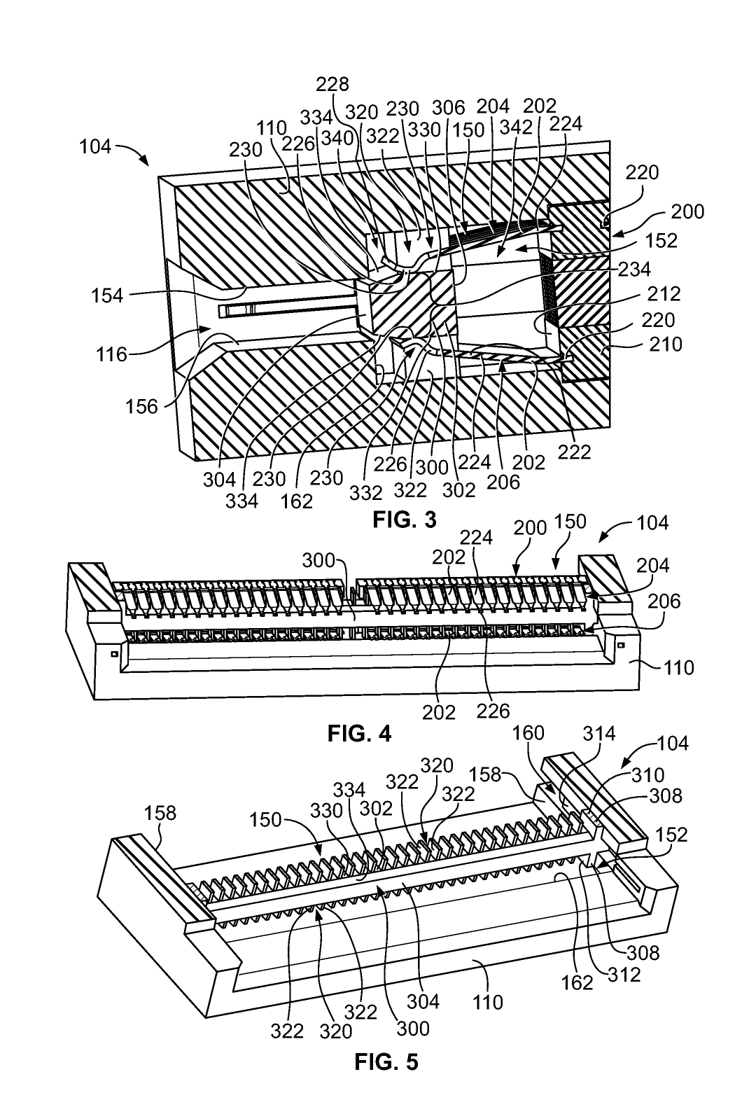

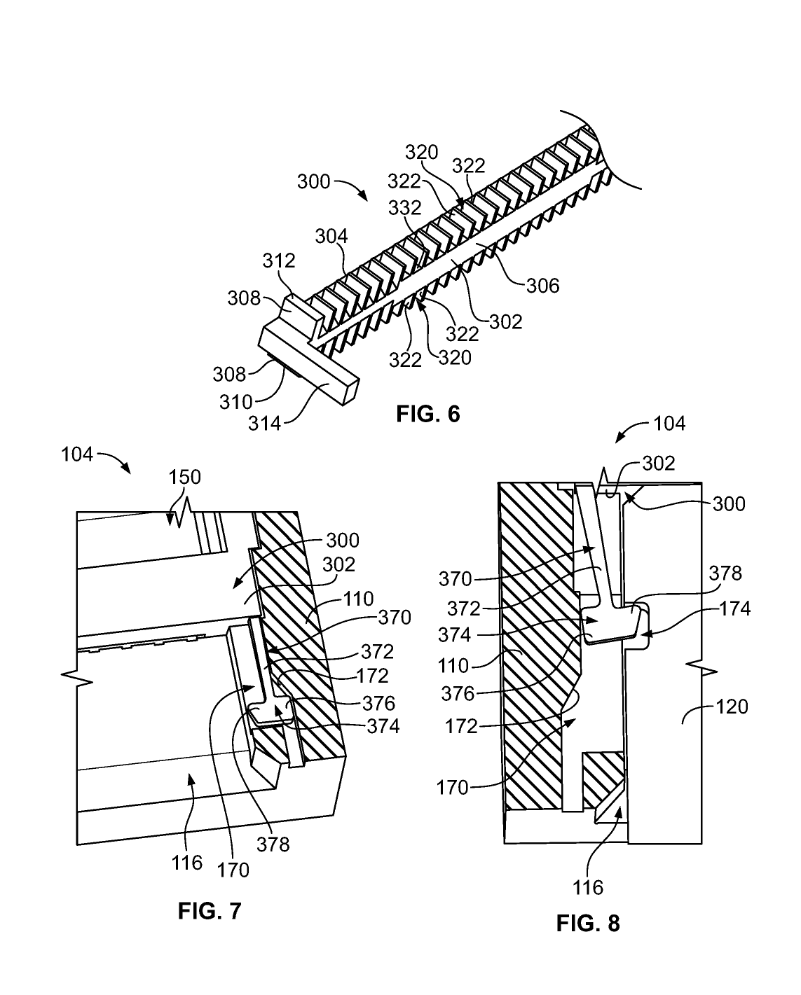

FIG. 5 is a partial sectional view of the receptacle connector 104 in accordance with an exemplary embodiment showing the insert 300 in the cavity 150 of the housing 110. A portion of the upper wall of the housing 110 is removed to illustrate the insert 300. FIG. 5 illustrates the receptacle connector 104 without the contact assembly 200 to illustrate the insert 300. FIG. 6 is a bottom perspective view of the insert 300.

The insert 300 includes a main body 302 extending between a front wall 304 and a rear wall 306. The insert 300 includes end walls 308 at opposite ends of the main body 302. The end walls 308 extend between a top 310 and a bottom 312 of the insert 300. The end walls 308 may abut against end walls 158 (FIG. 5) of the housing 110 at opposite ends of the cavity 150. Optionally, the top 310 may engage a top wall of the housing 110 and the bottom 312 may engage a bottom wall of the housing 110 to orient the insert 300 within the cavity 150. In an exemplary embodiment, the insert 300 includes guide rails 314 configured to be received in the guide slots 160 in the end walls 158 of the housing 110. The guide rails 314 may guide forward and rearward movement of the insert 300 within the cavity 150. The end walls 308 may guide forward and rearward movement of the insert 300 within the cavity 150.

In an exemplary embodiment, the insert 300 includes a plurality of contact channels 320 along the top 310 and the bottom 312 of the insert 300. The contact channels 320 are separated by separating walls 322. Each contact channel 320 is configured to receive a corresponding contact 202 (shown in FIG. 4). The separating walls 322 are configured to electrically isolate the contacts 202 from each other. The separating walls 322 are configured to position the contacts 202 relative to each other. For example, the separating walls 322 may hold the contacts 202 at a predetermined pitch.

With additional reference back to FIG. 3, the main body 302 includes an upper land 330 for each contact 202 along the top of the main body 302 and a lower land 332 for each contact 202 along the bottom of the main body 302. The upper land 330 supports the tip 226 of each contact 202 in the upper row 204. The lower land 332 supports the tip 226 of each contact 202 in the lower row 206. The separating walls 322 extend from the upper lands 330 and the lower lands 332. The contact channels 320 are defined above the upper lands 330 and below the lower lands 332. In an exemplary embodiment, the main body 302 includes ramps 334 extending between the lands 330, 332 and the front wall 304. Optionally, the main body 302 may include ramps (not shown) extending between the lands 330, 332 and the rear wall 306. The rear ramp may be used for loading the contacts 202 into the contact channels 320 during assembly. The front ramps 334 may be used to release the contacts 202 against the circuit card 120 as the insert 300 is moved rearward from the forward position to the retracted position.

In the forward position (FIG. 3), the separating walls 322 are positioned between the tips 226. The dielectric material of the separating walls 322 fills the contact gaps 232 between the contacts 202 in the upper row 204 and in the lower row 206. For example, the separating walls 322 may partially fill the contact gaps 232 or the separating walls 322 may entirely filled the contact gaps 232. The dielectric material of the main body 302 at least partially fills a contact space 234 between the contacts 202 in the upper row 204 and the contacts 202 in the lower row 206. However, when the insert 300 is moved to the retracted position (FIG. 10), the insert 300 is moved rearward away from the tips 226. For example, the separating walls 322 may be moved rearward along the mating beams 224 and the tips 226 may be free of the dielectric material of the insert 300 therebetween. The tips 226 may be more exposed to air when the insert 300 is moved to the retracted position, which affects the electrical performance of the contacts 202 at the mating interfaces 230. For example, by reducing the amount of plastic material in the mating zone, the impedance may be increased. The high dielectric constant of the dielectric material of the insert 300 may be replaced by air, having a lower dielectric constant than the plastic material, thus raising the impedance in the mating zone by eliminating or removing the plastic material of the insert 300 from between or around the tips 226 of the contacts 202 in the mating zone.

In an exemplary embodiment, the receptacle connector 104 has a forward air gap 340 in the insert chamber 152 forward of the insert 300 and a rear air gap 342 in the insert chamber 152 rearward of the insert 300. The forward air gap 340 is defined between the front wall 304 and a front wall 162 of the cavity 150. The rear air gap 342 is defined between the rear wall 306 and the front wall 212 of the holder 210. The insert 300 is movable within the insert chamber 152 to change the size, shape and/or volume of the forward air gap 340 and the rear air gap 342. For example, when the insert 300 is in the forward position, the forward air gap 340 may be relatively small and the rear air gap 342 may be relatively large. However, when the insert 300 is in the retracted position (FIG. 10), the forward air gap 340 may be relatively large and the rear air gap 342 may be relatively small. By increasing the volume of air in the forward air gap 340 surrounding the tips 226 of the contacts 202 at the mating zone, the impedance of the contacts 202 may be affected. By decreasing the volume of air in the rear air gap 342, and increasing the amount of plastic material surrounding the mating beams 224 in the retracted position, the impedance of the contacts 202 along the mating beams 224 may be decreased. Optionally, the size and shape of the insert 300 may be selected to control the impedance in the mating zone along the tips 226 and along the mating beams 224 for impedance matching along the length of the contacts 202. For example, the impedance along the tips 226 and along the mating beams 224 may be closer than conventional receptacle connectors that provide plastic material along the entire lengths of the contacts 202, such as along the mating beams 224 and along the tips 226. By moving the insert 300 rearward, the amount of plastic material in the mating zone along the tips 226 may be reduced to increase the impedance of the contacts 202 along the tips 226.

FIG. 7 is a partial sectional view of a portion of the receptacle connector 104 showing the insert 300 in the cavity 150 of the housing 110 in the forward position. FIG. 8 is a partial sectional view of a portion of the receptacle connector 104 showing the insert 300 in the cavity 150 of the housing 110 in the retracted position. FIG. 8 illustrates the circuit card 120 received in the housing 110.

In an exemplary embodiment, the insert 300 includes an extractor 370 extending forward of the main body 302. The extractor 370 may be integral with the main body 302, such as being molded with the main body 302 during manufacture to form a monolithic structure. Alternatively, the extractor 370 may be separately manufactured from the main body 302 and coupled to the main body 302. For example, the extractor 370 may be manufactured from a metal material while the main body 302 is manufactured from a dielectric material. The extractor 370 is used for moving the insert 300 from the retracted position (FIG. 8) to the forward position (FIG. 7). For example, the extractor 370 may engage the circuit card 120 in one or more positions, such as in the retracted position. When the circuit card 120 is pulled out of the housing 110, the circuit card 120 moves the extractor 370, and thus the insert 300, forward to the forward position.

The extractor 370 includes an arm 372 and a finger 374 at the distal end of the arm 372. The arm 372 extends from the main body 302. The finger 374 includes a base 376 at an exterior and a tip 378 at an interior (facing the cavity 150). The tip 378 faces the slot 116. The base 376 faces the wall of the housing 110. The arm 372 is deflectable to extend the tip 378 into the slot 116 to engage the circuit card 120.

The housing 110 includes an extractor guide slot 170 formed in the end wall of the housing 110, such as along the slot 116. The extractor guide slot 170 is open to the slot 116. The extractor guide slot 170 includes a cam surface 172. The extractor 370 is configured to engage the cam surface 172 to extend the finger 374 into the slot 116 to engage the circuit card 120. For example, the base 376 rides along the cam surface 172 to force the tip 378 inward into the slot 116. In an exemplary embodiment, the circuit card 120 includes a cutout 174. The tip 378 is received in the cutout 174 to engage the circuit card 120. When the circuit card 120 is pulled forward out of the housing 110, the circuit card 120 directs the extractor 370 and the insert 300 forward. The extractor 370 releases from the circuit card 120 when the base 376 moves along the cam surface 172. The finger 374 retracts back into the extractor guide slot 170, out of the slot 116, to release the circuit card 120. As such, the circuit card 120 may be used to reset the insert 300 in the forward position.

FIG. 9 is a partial sectional view of the receptacle connector 104 in accordance with an exemplary embodiment. FIG. 9 shows the circuit card 120 received in the housing 110. FIG. 9 shows the contacts 202 mated with the contact pads 128 of the circuit card 120. The insert 300 is shown in the retracted position, pushed rearward toward and/or against the holder 210. In an exemplary embodiment, during loading of the circuit card 120 into the housing 110, the card edge 126 abuts against the front wall 304 of the insert 300. Loading of the circuit card 120 further into the slot 116 forces the insert 300 to move rearward to the retracted position. The circuit card 120 is used to push the insert 300 from the forward position (FIG. 3) to the retracted position (FIG. 9). The extractor 370 is shown in the corresponding cutout 174.

When the insert 300 is in the retracted position, the contacts 202 extend forward of the insert 300. The separating walls 322 are pushed rearward of the tips 226 of the contacts 202, such as along the mating beams 224. The separating walls 322 guide and position the contacts 202 but the separating walls 322 are not located between the tips 226 of the contacts 202. The contact gaps 232 between the tips 226 are filled with air, rather than the plastic material of the insert 300.

FIG. 10 is a partial sectional view of the receptacle connector 104 in accordance with an exemplary embodiment. FIG. 10 shows the circuit card 120 received in the housing 110. FIG. 10 shows the contacts 202 mated with the circuit card 120. The insert 300 is shown in the retracted position adjacent the holder 210. The main body 302 is located between the mating beams 224 in the upper and lower rows 204, 206. The tips 226 are located forward of the insert 300. The circuit card 120 is shown in the contact space 234 between the upper and lower rows 204, 206. When the tips 226 of the contacts 202 are released from the insert 300 (for example, as the insert 300 is moved rearward toward the retracted position), the contacts 202 are moved inward toward each other to engage the upper and lower surfaces 122, 124 of the circuit card 120 for mating with the contact pads 128. In an exemplary embodiment, the contacts 202 are deflected such that the contacts 202 are spring loaded against the contact pads 128 to ensure electrical contact therewith. The tips 226 of the contacts 202 to ride along the ramps 334 as the insert 300 is moved forward and rearward between the forward position in the retracted position. The ramps 334 allow a smooth transition to or from the circuit card 120 during loading or unloading of the circuit card 120.

FIG. 11 is a partial sectional view of the communication system 100 showing the pluggable module 106 partially loaded into the receptacle connector 104. In the illustrated embodiment, the receptacle connector 104 includes a return spring 400 coupled to the insert 300 and biasing the insert 300 forward toward the forward position. The return spring 400 is held in the housing 110 and is operably coupled to the insert 300. The return spring 400 may be located in a pocket 402 along the end wall 158. In the illustrated embodiment, the return spring 400 is a coil spring; however, other types of biasing members may be used in alternative embodiments. FIG. 11 illustrates rear ramps 336 on the insert 300 at the rear wall 306.

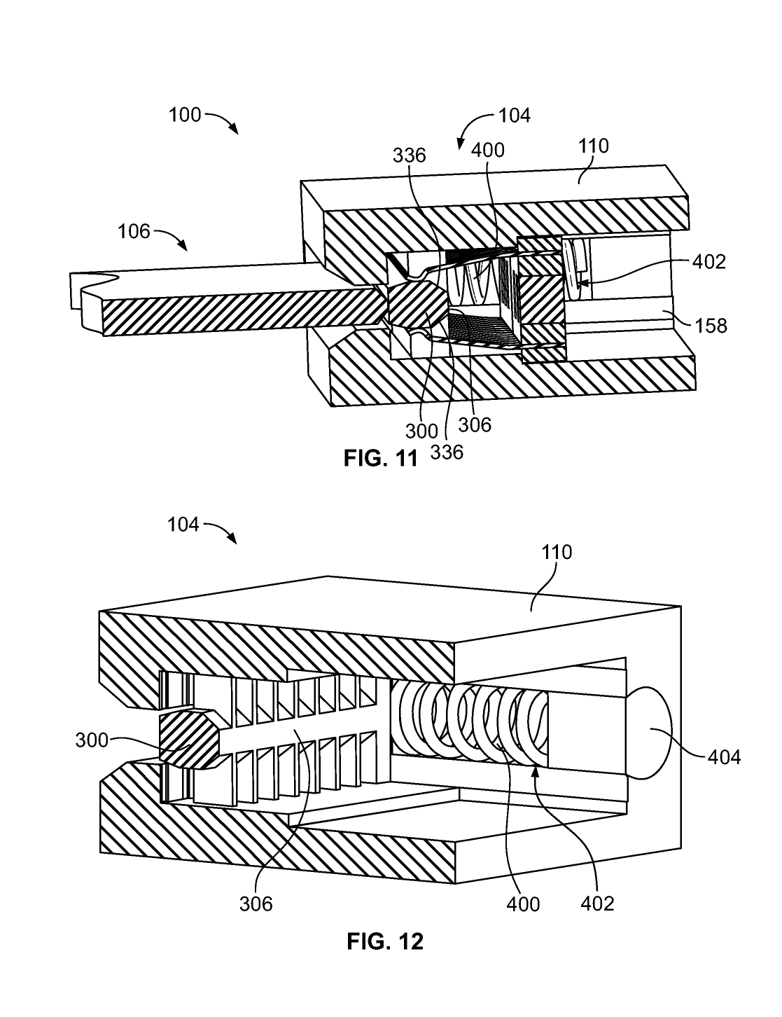

FIG. 12 is a partial sectional view of the receptacle connector 104 in accordance with an exemplary embodiment with the contact assembly 200 removed to illustrate the return spring 400 in the housing 110 operably coupled to the insert 300. In an exemplary embodiment, the return spring 400 is held in the pocket 402 by a plug 404. The return spring 400 engages the rear wall 306 of the insert 300 to push the insert 300 forward. The return spring 400 may be used in lieu of the extractors 370 (shown in FIGS. 7 and 8) to return the insert 300 to the forward position.

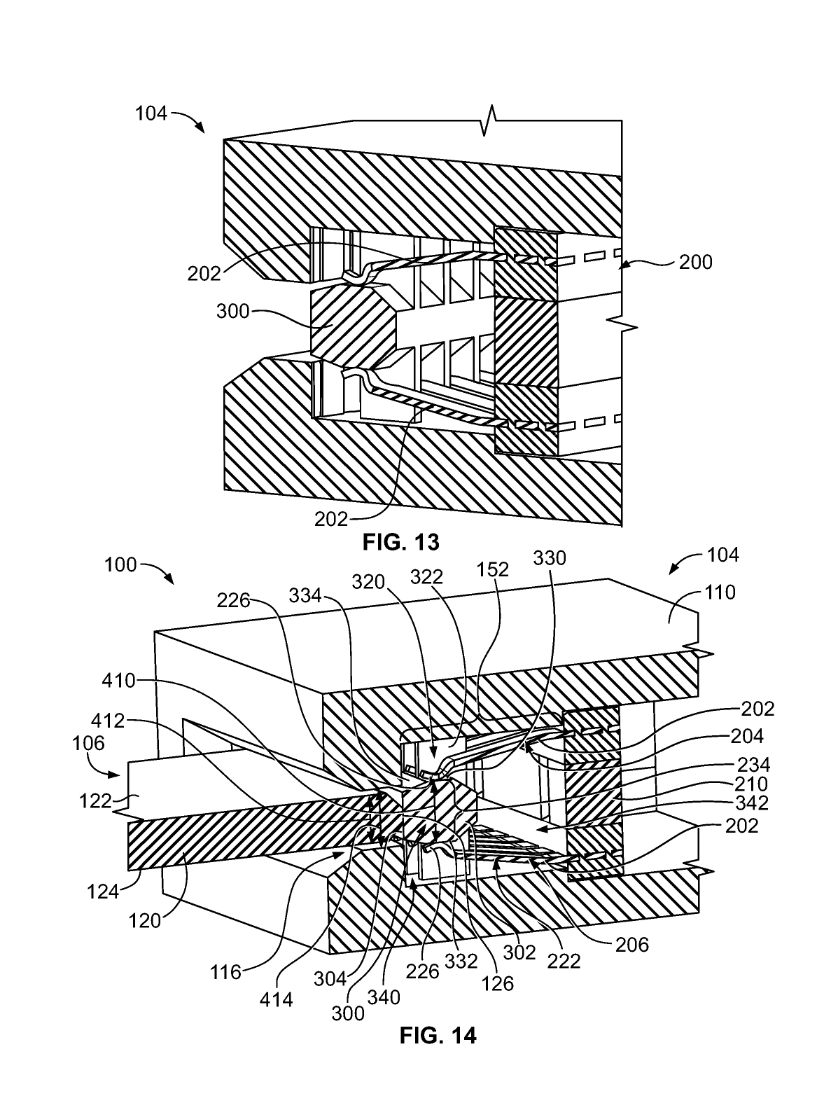

FIG. 13 is a partial sectional view of the receptacle connector 104 in accordance with an exemplary embodiment showing the insert 300 in the forward position supporting the contacts 202 of the contact assembly 200.

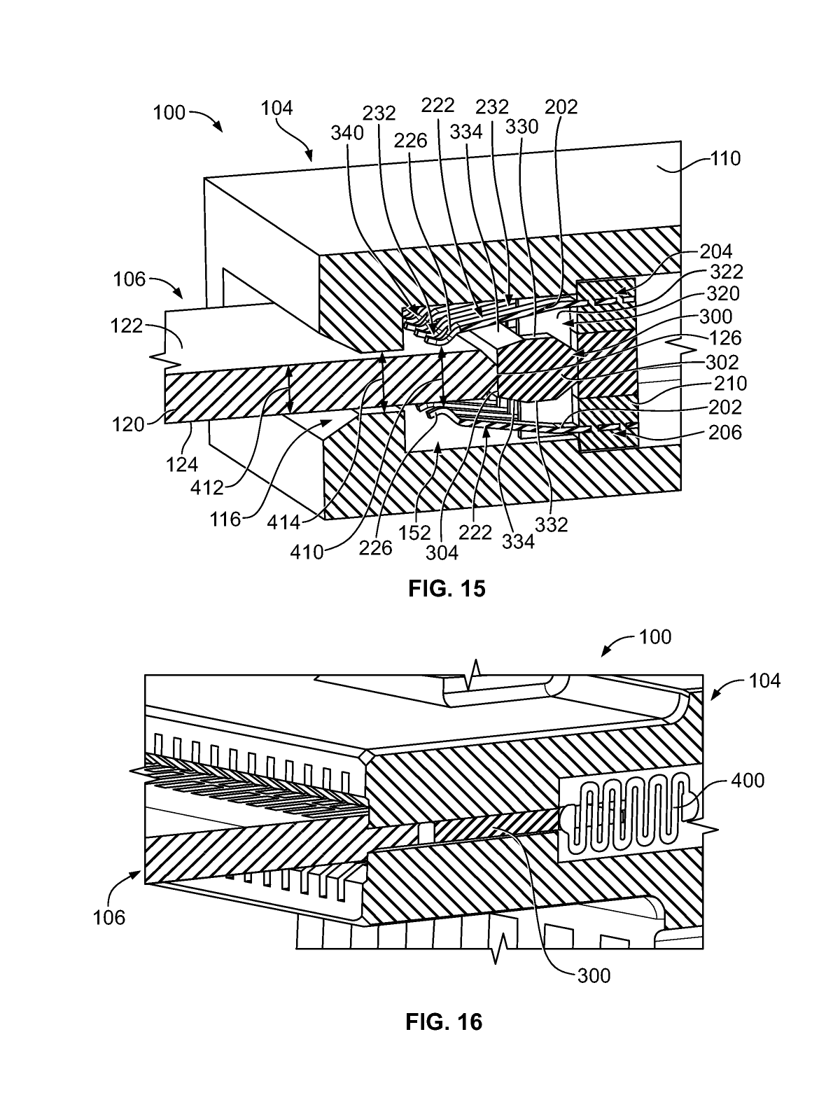

FIG. 14 is a partial sectional view of the communication system 100 showing the pluggable module 106 partially mated with the receptacle connector 104. FIG. 15 is a partial sectional view of the communication system 100 showing the pluggable module 106 fully mated with the receptacle connector 104. The insert 300 is shown in the forward position in FIG. 14. The insert 300 is shown in the retracted position in FIG. 15.

The front wall 304 faces the slot 116. The front wall 304 is configured to engage the circuit card 120 when the circuit card 120 is received in the slot 116 to push the insert 300 rearward to the retracted position.

The contacts 202 are shown in the contact channels 320 with the separating walls 322 between the adjacent contacts 202. In the forward position, the separating walls 322 are positioned between the tips 226 of the contacts 202. The tips 226 are supported by the upper lands 330 and the lower lands 332. The insert 300 holds the tips 226 of the contacts apart, in the forward position, a first distance 410 greater than a thickness 412 of the circuit card 120. The first distance 410 may be greater than a height 414 of the slot 116. For example, the height 414 of the slot 116 may be approximately equal to the thickness 412 of the circuit card 120 to locate the circuit card 120 in the housing 110. The mating ends 222 of the contacts 202 are released from the main body 302 of the insert 300 to engage the circuit card 120 when the insert 300 is moved to the retracted position. The main body 302 of the insert 300 has a thickness that defines the first distance 410. The thickness is greater than the thickness 412 of the circuit card 120. By holding the contacts 202 apart by the first distance 410, greater than the thickness 412 of the circuit card 120, the circuit card 120 may be loaded into the contact the space 234 between the upper and lower rows 204, 206 of contacts without risk of mechanical stubbing or damage to the contacts 202 during loading.

As the insert 300 is transitioned to the retracted position, the insert 300 is moved in the insert chamber 152 toward the holder 210. The tips 226 of the contacts 202 are eventually released from the insert 300 by sliding along the ramps 334 to the upper and lower surfaces 122, 124 of the circuit card 120. In an exemplary embodiment, the entire insert 300 is rearward of the tips 226 of the mating ends 222 of the contacts 202 in the retracted position. For example, the tips 226 are located forward of the front wall 304. The front wall 304 is pushed rearward of the tips 226 by the card edge 126 of the circuit card 120. The separating walls 322 are slidable relative to the contacts 202 has the insert 300 is moved between the forward position and the retracted position.

The upper lands 330 support the mating ends 222 of the contacts 202 in the upper row 204 in the forward position and the lower lands 330 to support the mating ends 222 of the contacts 202 in the lower row 206 in the forward position. The upper lands 330 and the lower lands 330 to deflect the mating ends 222 of the contacts 202 outward to preload the contacts 202 with an internal preload force causing the contacts 202 spring inward when released. The insert 300 fills the contact gaps 232 with the dielectric material of the separating walls 322 in the forward position. The mating ends 222 of the contacts 202 are released from the insert 300 when the insert 300 is moved to the retracted position. For example, the upper lands 330 are positioned rearward of the mating ends 222 of the contacts 202 in the upper row 204 in the retracted position and the lower lands 332 are positioned rearward of the mating ends 222 of the contacts 202 in the lower row 206 in the retracted position. The mating ends 222 are released to engage the circuit card 120. The contact gaps 232 between the tips 226 are filled with air when the insert 300 is in the retracted position. The volume of the forward air gap 340 is increase as the insert 300 is moved from the forward position to the retracted position.

FIG. 16 illustrates a portion of the communication system 100 showing the pluggable module 106 partially mated with the receptacle connector 104. A portion of the receptacle connector 104 is shown in section to illustrate the return spring 400 in accordance with an exemplary embodiment. In the illustrated embodiment, the return spring 400 is a serpentine spring engaging the insert 300. The return spring 400 is compressible when the insert 300 is moved to the retracted position.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

1. An electrical connector system comprising:
a receptacle connector having a housing, a contact assembly held in the housing and an insert movably received in the housing and supporting the contact assembly;
the contact assembly including contacts arranged in an upper row and a lower row, the contacts having mating ends;
the housing having a cavity receiving the contact assembly, the housing having a mating end including a slot open to the cavity and configured to receive a circuit card having contact pads on an upper surface and a lower surface of the circuit card for mating with the upper and lower rows of contacts;
the insert including a front, the insert being received in the cavity and being movable in the cavity between a forward position and a retracted position, the insert being manufactured from a dielectric material, the front of the insert being positioned forward of the mating ends in the forward position with the insert supporting the mating ends of the contacts in the forward position, the front of the insert being positioned rearward of the mating ends in the retracted position with the mating ends being released from the insert in the retracted position and the mating ends being more exposed to air when the insert is in the retracted position.

2. The electrical connector system of claim 1, further comprising a return spring held in the housing being operably coupled to the insert, the return spring biasing the insert forward toward the forward position.

3. The electrical connector system of claim 1, wherein the insert includes a front wall facing the slot, the front wall being configured to engage the circuit card when the circuit card is received in the slot to push the insert rearward to the retracted position.

4. The electrical connector system of claim 1, wherein the insert includes contact channels separated by separating walls, each contact channel receiving a corresponding contact, the mating ends of the contacts being positioned in the contact channels between the separating walls when the insert is in the forward position, the separating walls being moved rearward of the mating ends of the contacts when the insert is moved to the retracted position.

5. The electrical connector system of claim 4, wherein the separating walls are slidable relative to the contacts as the insert is moved between the forward position and the retracted position.

6. The electrical connector system of claim 1, wherein the cavity includes an insert chamber, the insert being movable in the insert chamber between the forward position and the retracted position.

7. The electrical connector system of claim 1, wherein a portion of the insert is forward of the mating ends of the contacts in the forward position and wherein the entire insert is rearward of the mating ends of the contacts in the retracted position.

8. The electrical connector system of claim 1, wherein the insert holds the mating ends of the contacts apart in the forward position a first distance greater than a thickness of the circuit card, the mating ends of the contacts being released to engage the circuit card when the insert is moved to the retracted position.

9. The electrical connector system of claim 1, wherein the insert includes a main body having upper lands on a top of the main body and lower lands on a bottom of the main body, the upper lands supporting the mating ends of the contacts in the upper row in the forward position and the lower lands supporting the mating ends of the contacts in the lower row in the forward position, the upper lands being positioned rearward of the mating ends of the contacts in the upper row in the retracted position and the lower lands being positioned rearward of the mating ends of the contacts in the lower row in the retracted position.

10. The electrical connector system of claim 9, wherein the upper lands are separated from the lower lands by a distance greater than a height of the slot, the upper lands and the lower lands deflecting the mating ends of the contacts outward to preload the contacts with an internal preload force.

11. The electrical connector system of claim 1, wherein adjacent mating ends of the contacts are separated by corresponding contact gaps, the insert filling the contact gaps with dielectric material in the forward position, the contact gaps being filled with the air when the insert is in the retracted position.

12. The electrical connector system of claim 1, wherein the contact assembly includes a holder holding the contacts, the holder being fixed in the cavity, the insert being movable relative to the holder in the cavity between the forward position and the retracted position.

13. The electrical connector system of claim 1, further comprising a forward air gap forward of the insert and a rear air gap rearward of the insert, a volume of the forward air gap increasing as the insert is moved from the forward position to the retracted position.

14. The electrical connector system of claim 1, wherein the insert includes an extractor configured to engage the circuit card in the retracted position, the extractor and the insert being pulled forward to the forward position by the circuit card when the circuit card is removed from the slot.

15. The electrical connector system of claim 1, wherein the housing includes an extractor guide slot having a cam surface, the insert including an extractor extending forward of a main body of the insert, the extractor being located in the extractor guide slot and being configured to engage the cam surface to move into the slot and engage the circuit card in the slot.

16. An electrical connector system comprising:
a receptacle connector having a housing, a contact assembly held in the housing and an insert movably received in the housing and supporting the contact assembly;
the contact assembly including contacts arranged in an upper row and a lower row, the contacts having mating ends;
the housing having a cavity receiving the contact assembly, the housing having a mating end including a slot open to the cavity, the slot having a height, the slot being configured to receive a circuit card having contact pads on an upper surface and a lower surface of the circuit card for mating with the upper and lower rows of contacts;
the insert including a front, the insert being received in the cavity and being movable in the cavity between a forward position and a retracted position, the insert being manufactured from a dielectric material, the insert having a main body including a front, the main body including an upper land and a lower land separated by a distance greater than the height of the slot, the front being positioned forward of the mating ends in the forward position, the insert supporting the mating ends of the contacts in the forward position with the mating ends of the contacts in the upper row being supported by the upper land in a deflected position and with the mating ends of the contacts in the lower row being supported by the lower land in a deflected position such that the contacts are preloaded against the insert, the front of the insert being positioned rearward of the mating ends in the retracted position, the mating ends being released from the insert and positioned closer to each other in the retracted position compared to the forward position for mating the contacts with the contact pads of the circuit card.

17. The electrical connector system of claim 16, wherein the dielectric material of the insert is positioned between the mating ends of the contacts when the insert is in the forward position and wherein the mating ends of the contacts are more exposed to air when the insert is in the retracted position.

18. The electrical connector system of claim 16, wherein the insert includes contact channels separated by separating walls, each contact channel receiving a corresponding contact, the mating ends of the contacts being positioned in the contact channels between the separating walls when the insert is in the forward position, the separating walls being moved rearward of the mating ends of the contacts when the insert is moved to the retracted position.

19. The electrical connector system of claim 16, wherein a portion of the insert is forward of the mating ends of the contacts in the forward position and wherein the entire insert is rearward of the mating ends of the contacts in the retracted position.

20. An electrical connector system comprising:
a receptacle connector having a housing, a contact assembly held in the housing and an insert movably received in the housing and supporting the contact assembly;
the contact assembly including a contact holder arranged in the cavity, the contact assembly including contacts held by the holder in an upper row and a lower row, the contacts having mating ends including mating beams and tips at distal ends of the mating beams having mating interfaces, the mating beams extending forward of the contact holder;
the housing having a cavity receiving the contact assembly, the housing having a mating end including a slot open to the cavity and configured to receive a circuit card having contact pads on an upper surface and a lower surface of the circuit card for mating with the upper and lower rows of contacts;
the insert being received in the cavity and being movable in the cavity between a forward position and a retracted position, the insert being positioned remote from the contact holder in the forward position, the insert being moved toward the contact holder as the insert moves to the retracted position, the insert being manufactured from a dielectric material, the insert having a main body and separating walls extending from the main body defining contact channels therebetween, the contact channels receiving corresponding contacts, wherein the mating interfaces of the contacts are in the contact channels between corresponding separating walls when the insert is in the forward position, and wherein the mating interfaces are forward of the insert when the insert is moved rearward in the retracted position.
